(19) United States
(12) Patent Application Publication
(10) Pub. No.: US 2013/0179325 A1
(43) Pub. Date: Jul. 11, 2013

(54) System and Method for Underwriting and Transferring Existing Credit Card Balances to a Credit Instrument Issuing Facility

(71) Applicant: Milan Perlly, Richmond, VA (US)

(72) Inventor: Milan Perlly, Richmond, VA (US)

(21) Appl. No.: 13/180,595

(22) Filed: Jul. 12, 2011

(51) Int. Cl. G06Q 20/24

(52) U.S. Cl. CPC G06Q 20/24
USPC 705/38

(57) ABSTRACT

A system for transferring existing credit card balances to a credit instrument issuing facility including a refinance entity in communication with cardholders of one or more credit card accounts, at least one credit reporting agency in communication with the refinance entity for providing credit reports to the refinance entity; at least one credit instrument issuing facility in communication with the refinance entity for accepting a summary report of the inputted application forms including a blended annual percentage rate from the refinance entity, the at least one credit instrument issuing facility capable of issuing a refinanced debt credit card account to the cardholders to replace all of the one or more credit card accounts, wherein the refinance entity closes all of the one or more credit card accounts, transfers all of the balances of the credit card accounts to the credit instrument issuing facility, issues the refinanced debt credit card account.

### TECHNICAL FIELD OF THE INVENTION

This invention relates, in general, to a system and method for underwriting and transferring existing credit balances and, in particular, to a system and method for underwriting and transferring existing credit card balances to a credit instrument issuing facility.

### BACKGROUND OF THE INVENTION

Without limiting the scope of the present invention, its background will be described in relation to a system and method for underwriting and transferring existing credit card balances to a credit instrument issuing facility, as an example.

Consumers have long enjoyed the benefits of credit, and particularly credit cards have become popular with consumers due to the convenience of purchasing more expensive items easily and paying for them over a period of time. Many consumers have more than one credit cards through either the same or multiple financial institutions, lending institutions, creditors, banks (collectively “credit instrument issuing facilities” or “CIIFs”) or through different credit instrument issuing facilities. Oftentimes, each one of these credit cards each have different terms, such as credit limits, purchase interest rates, balance transfer interest rates, cash advance interest rates, payment due dates, annual fees, etc.

Today, consumers may apply for additional credit cards through their existing credit instrument issuing facilities or through different credit instrument issuing facilities. When the application is approved and credit is granted, the credit instrument issuing facility will then issue the new additional credit card to the consumer. The consumer may choose to keep all of their existing credit card accounts open. By opening a new credit card account and keeping the existing credit card accounts open, the consumer has increased his/her exposed credit risk and negatively affected his/her credit profile rating. The consumer may also choose to transfer some or all of their existing credit card account balances to the new card issued by the credit instrument issuing facility to take advantage of teaser introductory balance transfer rates. However, in most situations, the newly issued credit card limit is unable to accommodate a balance transfer of the total balances of all the existing credit cards, even if that is the intent of the consumer. Transferring existing credit card balances by the consumer from one credit instrument issuing facility to another credit instrument issuing facility is not obligatory either. In fact, the consumer may not fulfill on such a stated balance transfer transaction, even if the consumer intended to do so in the first place. From a credit risk underwriting perspective, this further negatively impacts the consumer's open credit risk as the consumer just opened additional credit lines without closing or eliminating existing credit lines.

Credit instrument issuing facilities issuing the credit card may desire to have all of the existing credit card balances of a consumer/new card applicant be transferred to it for various beneficial reasons, such as increased market share of credit card debt, immediate generation of revenue from interest charged on the balances transferred, increased profitability, increased ratio of profitable consumers, and the like.

Several attempts have been made to facilitate the transfer of existing credit card balances to a credit instrument issuing facility. In one attempt, a credit instrument issuing facility that issues credit cards to a pool of consumers, may select a subset of consumers, based upon some criteria, and ask them to apply and to transfer existing credit card balances from another credit instrument issuing facility. It may offer lower teaser balance transfer interest rates as an enticement.

In this instance, the selected subset of cardholders may be less profitable cardholders that the credit instrument issuing facility wishes to transfer to the other credit instrument issuing facility where such consumers may better match their business model. In this attempt, just those credit cards serviced by the credit instrument issuing facility may be transferred, not the other ones serviced by other credit instrument issuing facilities.

In another attempt, a system provides consumers with Internet displayed pages for inputting existing credit card terms or desired credit card terms and/or criteria, and then analyzes existing credit instrument issuing facilities' credit card offers based on the entered criteria from the consumer to find matching ones that are then displayed to a consumer for consideration. Displayed offers may then be accepted by the consumer. This method is performed one credit card at a time, so if the consumer has several credit cards, they must go through this process for each credit card.

In yet another attempt, Internet pages or forms are displayed to a consumer seeking credit whereby they may enter background information about themselves and their credit profile. The information is stored on a database and a credit score is obtained on the consumer and also saved to the database. The stored information is then analyzed and filtered such that it provides pertinent data relating to the consumer to a plurality of potential credit instrument issuing facilities. The filtered information may be transferred to the potential credit instrument issuing facilities via lender-specific interfaces, in one instance. The credit instrument issuing facilities analyze the filtered data and determine whether it desires to accept the application and provide offers. If one or more of the credit instrument issuing facilities accept the application for credit, then they provide offers to the consumer. The consumer may then select between the one or more displayed offers for credit. This attempt does not include credit underwriting functionality for transferring all of the existing credit card balances to the accepted credit instrument issuing facility by the consumer once the offer is accepted by the consumer.

### SUMMARY OF THE INVENTION

Without limiting the scope of the present invention, its background will be described in relation to a system and method for underwriting and transferring existing credit card balances of a consumer to a credit instrument issuing facility. In one embodiment, the system and method for underwriting and transferring existing credit card balances to a credit instrument issuing facility provides for unique underwriting, refinancing, and transferring the entire existing, outstanding credit balances and credit limits of all of a consumer's multiple credit cards into a single new credit card.

The successful completion of this underwriting transaction results in closing the account(s) of the existing, outstanding credit card(s) from which the balances were transferred out and refinanced. Additionally, the current credit limit of each of the existing credit card(s) are cumulatively consolidated and are reflected in the credit limit of the new single credit card account that is granted and/or issued.

Further, the system and method for underwriting and transferring existing credit card balances to a credit instrument issuing facility allows consumers to participate in an underwriting process and apply for a new credit card by listing their current credit card account(s), the associated existing balances, the existing credit limits, the existing interest rates, the existing membership/annual fees, their pertinent personal information, their credit profile etc. Subsequently, consumers will receive, in real-time, a number of competing, guaranteed pre-approved offers, from credit instrument issuing facilities vying for the consumers who applied for the new product, which consolidates existing debts and credit limits into a single credit card.

In another embodiment, the system and method for underwriting and transferring existing credit card balances to a credit instrument issuing facility may include a refinance entity in communication with cardholders of one or more credit card accounts, the refinance entity capable of providing application forms to the cardholders for inputting information regarding the one or more credit card accounts for applying to refinance all of the one or more credit card accounts, the application forms including fields for at least one or more credit card account's credit limit, existing balance, and fixed annual percentage rate associated with the each of the one or more credit card accounts; at least one credit reporting agency in communication with the refinance entity for providing credit reports of the cardholders to the refinance entity; and at least one credit instrument issuing facility in communication with the refinance entity for accepting a summary report of the inputted application forms including a blended annual percentage rate from the refinance entity, the at least one credit instrument issuing facility capable of issuing a refinanced debt credit card account to the cardholders to replace all of the one or more credit card accounts, wherein the refinance entity controls the closing all of the one or more credit card accounts, transferring of the balances of the credit card accounts to the at least one credit instrument issuing facility, and issuing of the refinanced debt credit card account.

In one aspect, the refinance entity may provide a proxy authority to be authorized by the cardholders authorizing the refinance entity to close all of the one or more credit card accounts and transfer the all of the balances of one or more credit card accounts to the single credit card granted/issued by at least one credit instrument issuing facility.

In another aspect, the at least one credit instrument issuing facility may provide a preapproved balance transfer offer to the refinance entity based on the summary report. Further, the refinance entity may provide the preapproved balance transfer offer to the cardholders for viewing the preapproved balance transfer offers to make a selection for one of the preapproved balance transfer offers. Also, the blended annual percentage rate may be an average of all of the annual percentage rates of all of the one or more credit card accounts provided by cardholders.

In one aspect, the summary report may provide a total of each of the fields for the at least one of credit limit and existing balance associated with the each of the one or more credit card accounts. Further, issuing of the refinanced debt credit card account may include a credit limit at least equal to all transferred credit limits and a fixed annual percentage rate that is less than, more than, or is the same as the verified blended annual percentage rate of the existing credit cards.

In another embodiment, the electronic computer based system for transferring existing credit card balances to a credit instrument issuing facility may include an electronic input device for producing input signals; a display; an electronic memory storing application forms for one or more credit card accounts of a cardholder, the application forms including at least one of credit limit, existing balance, and fixed annual percentage rate associated with the each of the one or more credit card accounts; an electronic processor communicating with the memory and the display and responsive to input signals to: direct the display to display the application forms to the cardholder for receiving input of the at least one of credit limit, existing balance, and fixed annual percentage rate associated with the each of the one or more credit card accounts; receive input into the data fields relating to the at least one of credit limit, existing balance, and fixed annual percentage rate associated with the each of the one or more credit card accounts; receive a credit score report for the cardholder; transmit to one or more credit instrument issuing facilities a summary report containing the at least one of the credit limit, existing balance, and fixed annual percentage rate associated with the each of the one or more credit card accounts and the credit score report; receive one or more preapproved balance transfer offers from one or more credit instrument issuing facilities based on the summary report; transmit to the cardholder the one or more preapproved balance transfer offers including an apply selection and proxy selection for each preapproved balance transfer offers; responsive to selecting one of the apply selections and proxy selections associated with one of the one or more credit instrument issuing facilities by the cardholder, transmit the accepted preapproved balance transfer offer to the credit instrument issuing facility; receive acceptance from the accepted credit instrument issuing facilities for transferring the one or more credit card accounts; and responsive to receiving the acceptance from the accepted credit instrument issuing facility, transfer all balances and credit limits of the one or more credit card accounts to the accepted credit instrument issuing facility, and issue a refinanced debt credit card account from accepted credit instrument issuing facility to the cardholder.

In one aspect, the summary report may further include an average of the annual percentage rates for all of the one or more credit card accounts of the cardholder. In another aspect, the summary report may provide a total of each of the credit limit and existing balance associated with the each of the one or more credit card accounts. Also, the refinanced debt credit card account may include a credit limit at least equal to all transferred credit limits and a fixed annual percentage rate that is less than, more than, or is the same as the verified blended annual percentage rate of the existing credit cards.

In yet another embodiment, a method for underwriting and transferring existing credit card balances to a credit instrument issuing facility may include displaying to a cardholder one or more application forms including credit limit, existing balance, and fixed annual percentage rate associated with each of the one or more credit card accounts issued to the cardholder; inputting the credit limit, existing balance, and fixed annual percentage rate associated with each of the one or more credit card accounts issued to the cardholder; retrieving at least one credit score of the cardholder from one or more credit reporting agencies; preparing a summary report of the inputted application forms including a blended annual percentage rate of all of the annual percentage rates of the one or more credit card accounts, the retrieved at least one credit score, and a total of each of the fields for the credit limit and existing balance associated with the each of the one or more credit card accounts; transmitting the summary report to one or more credit instrument issuing facilities; transmitting to the cardholder one or more preapproved balance transfer offers provided by the one or more credit instrument issuing facilities; accepting one of the one or more preapproved balance transfer offers offered by the cardholder; transferring all of the one or more credit card accounts to the accepted credit instrument issuing facilities; and issuing a refinanced debt credit card account to the cardholder.

In one aspect, the transferring the one or more credit card accounts may be performed by a refinance entity in communication with the cardholder and the one or more credit instrument issuing facilities. In another aspect, the transmitting the summary report to one or more credit instrument issuing facilities may include determining interface methods of the one or more credit instrument issuing facilities.

Further, the transferring the one or more credit card accounts to the accepted credit instrument issuing facilities further may include transferring all of the balances of the one or more credit card accounts to the accepted credit instrument issuing facility. Also, transferring the one or more credit card accounts to the accepted credit instrument issuing facilities may further include transferring all of the credit limits of the one or more credit card accounts to the accepted credit instrument issuing facility.

Additionally, the retrieving at least one credit score of the cardholder may include retrieving a soft hit credit score from the one or more credit reporting agencies. In one aspect, the one or more credit instrument issuing facilities are subscribers to receiving the summary report. In another aspect, the method may include displaying on the application forms a proxy selection for authorizing to close all of the one or more credit card accounts, transferring of the balances of the credit card accounts to the credit instrument issuing facility, and issuing of the refinanced debt credit card account. In yet another aspect, the method may further include filtering the additional inputted information on the summary report.

### BRIEF DESCRIPTION OF THE DRAWINGS

For a more complete understanding of the features and advantages of the system and method for underwriting and transferring existing credit card balances to a credit instrument issuing facility, reference is now made to the detailed description of the system and method for underwriting and transferring existing credit card balances to a credit instrument issuing facility along with the accompanying figures in which corresponding numerals in the different figures refer to corresponding parts and in which:

FIG. 1 illustrates a block diagram of exemplary cardholders each having several credit card accounts and a credit instrument issuing facility according to an embodiment of the system and method for underwriting and transferring existing credit card balances to a credit instrument issuing facility;

FIG. 2 illustrates a block diagram of exemplary cardholders each having several credit card accounts, refinance entity, and credit instrument issuing facility according to an embodiment of the system and method for underwriting and transferring existing credit card balances to a credit instrument issuing facility;

FIG. 3 illustrates a block diagram of an exemplary cardholder having several credit card accounts, each issued by a different credit instrument issuing facility, refinance entity, and credit instrument issuing facility according to an embodiment of the system and method for underwriting and transferring existing credit card balances to a credit instrument issuing facility;

FIG. 4 illustrates a block diagram of exemplary communication links for transmitting information between cardholders and credit instrument issuing facilities and/or refinance entities according to an embodiment of the system and method for underwriting and transferring existing credit card balances to a credit instrument issuing facility;

FIG. 5 illustrates a block diagram of an exemplary network of computers for displaying a graphical user interface (“GUI”) to a cardholder and/or user according to an embodiment of the system and method for underwriting and transferring existing credit card balances to a credit instrument issuing facility;

FIG. 6 illustrates an exemplary screen shot from a GUI of an application form for inputting a consumer's personal information according to an embodiment of the system and method for underwriting and transferring existing credit card balances to a credit instrument issuing facility;

FIG. 7 illustrates another exemplary screen shot from a GUI of an application form for inputting information relevant to a consumer's existing credit card accounts and the attributes of the accounts according to an embodiment of the system and method for underwriting and transferring existing credit card balances to a credit instrument issuing facility;

FIG. 8 illustrates another exemplary screen shot from a GUI of an application form for inputting additional relevant personal information of a consumer according to an embodiment of the system and method for underwriting and transferring existing credit card balances to a credit instrument issuing facility;

FIG. 9 illustrates an exemplary screen shot from a GUI of a summary report reflective of a consumer's existing credit card accounts, attributes of the accounts, and a consumer's FICO score according to an embodiment of the system and method for underwriting and transferring existing credit card balances to a credit instrument issuing facility;

FIG. 10 illustrates an exemplary screen shot from a GUI of several preapproved credit card and balance transfer offers from credit instrument issuing facilities displaying terms of the offer according to an embodiment of the system and method for underwriting and transferring existing credit card balances to a credit instrument issuing facility;

FIG. 11 illustrates an exemplary screen shot from a GUI of an accepted preapproved balance transfer offer requesting additional information according to an embodiment of the system and method for underwriting and transferring existing credit card balances to a credit instrument issuing facility; and

FIGS. 12A-12B illustrate a block diagram of an exemplary process for transferring existing credit card balances to a lender according to an embodiment of the system and method for underwriting and transferring existing credit card balances to a credit instrument issuing facility.

### DETAILED DESCRIPTION OF THE INVENTION

While the making and using of various embodiments of the present system and method for underwriting and transferring existing credit card balances to a credit instrument issuing facility are discussed in detail below, it should be appreciated that it provides many applicable inventive concepts, which can be embodied in a wide variety of specific contexts. The specific embodiments discussed herein are merely illustrative of specific ways to make and use the system and method for underwriting and transferring existing credit card balances to a credit instrument issuing facility, and do not delimit the scope of it.

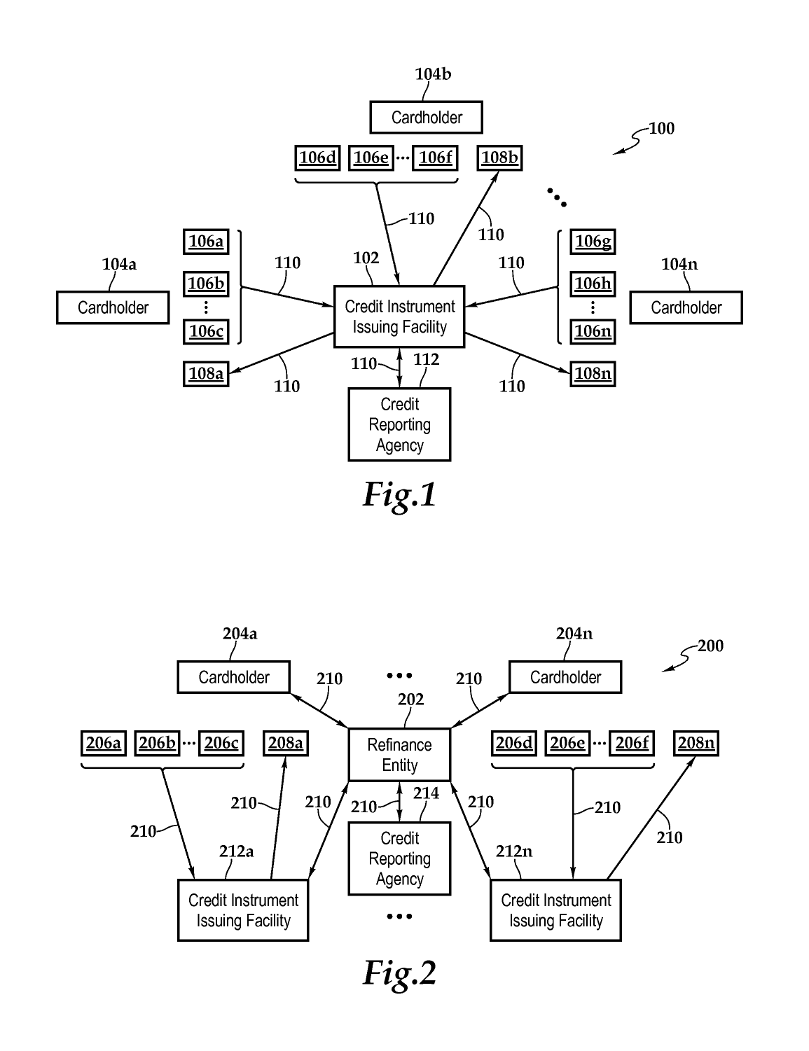

Referring initially to FIG. 1, an embodiment of a system for transferring existing credit card balances to a credit instrument issuing facility (“credit card balance transfer system”) 100 is shown that includes a credit instrument issuing facility 102 and an exemplary assortment of cardholders 104a-104n (collectively “cardholders 104”). Cardholders 104 may each have one or more credit card accounts. For example, cardholder 104a has credit card accounts 106a-106c; cardholder 104b has credit card accounts 106d-106f; and cardholder 104n has credit card accounts 106g-106n (credit card accounts 106a-106n are collectively “credit card accounts 106”).

In one embodiment, credit instrument issuing facility 102 may issue a single credit card account that replaces all of a particular cardholders 104 credit card accounts 106. The underwriting process will refinance and balance transfer all the existing balances from accounts 106a-106c as well as consolidate all the existing credit limits from accounts 106a-106c and may do so while simultaneously offering a better fixed interest rate on the balances transferred then the existing blended interest rate on the balances of the accounts 106a-106c. In return for applying and accepting credit card account 108a, cardholder 104a will agree to close accounts 106a-106c and transfer all the corresponding balances.

Cardholder 104a may be issued a refinanced debt credit card account 108a by credit instrument issuing facility 102 that replaces all of credit card accounts 106a-106c; cardholder 104b may be issued a refinanced debt credit card account 108b by credit instrument issuing facility 102 that replaces all of credit card accounts 106d-106f; and cardholder 104n may be issued a refinanced debt credit card account 108n by credit instrument issuing facility 102 that replaces all of credit card accounts 106g-106n. Collectively, refinanced debt credit card accounts 108a-108n are “refinanced debt credit card accounts 108.” As discussed further below with reference to FIG. 4, communications between credit instrument issuing facility 102 and cardholders 104 may be provided via one or more communication links 110.

As further described below, credit instrument issuing facility 102 may provide via one or more communication links 110 an application to cardholders 104 to transfer all of their existing credit card accounts 106 to credit instrument issuing facility 102. The application may request financial information from cardholders 104, such as full legal name, current address, email address, social security number, home telephone number, work telephone number, cellular phone number, annual income, monthly mortgage/rent expenses, names of the financial institutions of the existing credit card accounts 106, account numbers of credit card accounts 106, credit limits of credit card accounts 106, balances of credit card accounts 106, introductory interest rates of credit card accounts 106, regular annual percentage rate (“APR”), minimum payment information, annual fees, and the like.

In one embodiment, credit instrument issuing facility 102 communicates with one or more credit reporting agency 112 to transmit credit report requests and receive credit reports for cardholders 104.

Referring now to FIG. 2, another embodiment of a system for transferring existing credit card balances to a credit instrument issuing facility (“credit card balance transfer system”) 200 is shown that includes a refinance entity 202 and an exemplary assortment of cardholders 204a-204n (collectively “cardholders 204”). Cardholders 204 may each have one or more credit card accounts. For example, cardholder 204a has credit card accounts 206a-206c and cardholder 204n has credit card accounts 206d-206f (credit card accounts 206a-206f are collectively “credit card accounts 206”).

In one embodiment, refinance entity 202 may issue or may facilitate the issuance of a single credit card account that replaces all of particular cardholder's 204 credit card accounts 206. For example, cardholder 204a may be issued a refinanced debt credit card account 208a by a credit instrument issuing facility 212a that replaces all of credit card accounts 206a-206c and cardholder 204n may be issued a 208n by a credit instrument issuing facility 212n that replaces all of credit card accounts 206d-106f. Collectively, credit instrument issuing facilities 212a, 212n are referred to as “credit instrument issuing facilities 212.” Additionally, refinanced debt credit card accounts 208a, 208n are collectively “refinanced debt credit card accounts 208.” As discussed further below with reference to FIG. 4, communications between refinance entity 202, credit instrument issuing facilities 212, and cardholders 204 may be provided via one or more communication links 210.

In this embodiment, refinance entity 202 is in communication between credit instrument issuing facilities 212 and cardholders 204 for facilitating and/or transferring of existing credit card accounts 206 from cardholders 204 to respective credit instrument issuing facilities 212. Also, refinance entity 202 is in communication between credit instrument issuing facilities 212 and cardholders 204 for facilitating and/or transferring of refinanced debt credit card accounts 208 from credit instrument issuing facilities 212 to cardholders 204.

As further described below, refinance entity 202 may provide via one or more communication links 210 an application to cardholders 204 to transfer all of their existing credit card accounts 206 to one or more credit instrument issuing facilities 212. The application may request financial information from cardholders 204, such as name, address, email address, social security number, telephone numbers, annual income, monthly mortgage/rent expenses, names of the financial institutions of the existing credit card accounts 206, account numbers of credit card accounts 206, credit limits of credit card accounts 206, balances of credit card accounts 206, introductory interest rates of credit card accounts 206, regular APR, minimum payment information, annual fees, and the like.

In one embodiment, refinance entity 202 communicates with one or more credit reporting agency 214 to transmit credit report requests and receive credit reports for cardholders 204.

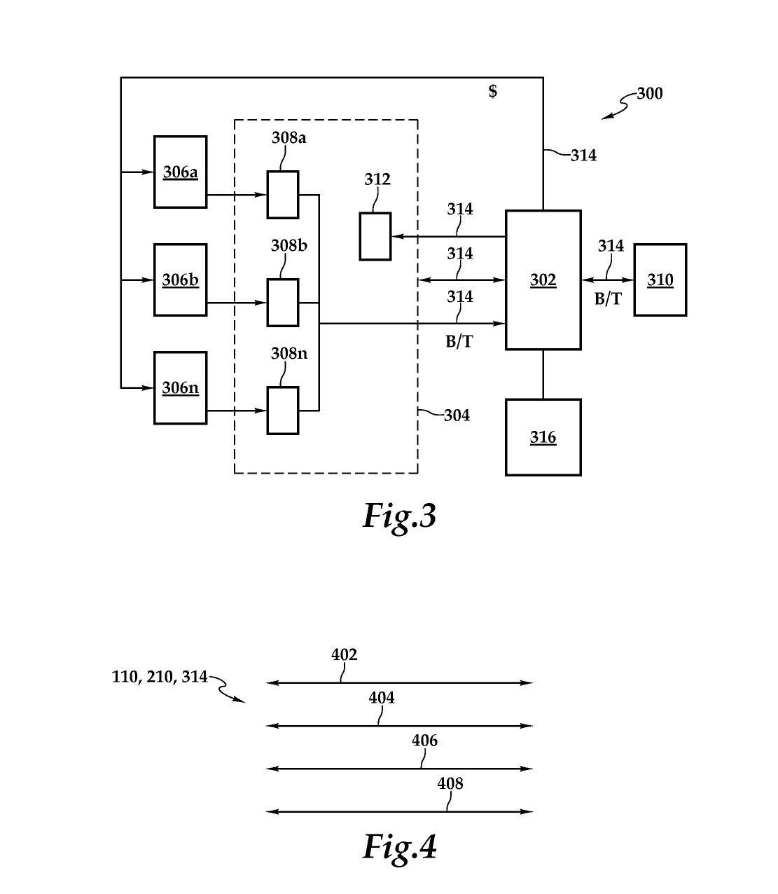

Now turning to FIG. 3, another embodiment of a system for transferring existing credit card balances to a credit instrument issuing facility (“credit card balance transfer system”) 300 is shown that includes a refinance entity 302 and an exemplary cardholder 304. In this embodiment, cardholder 304 has several credit card accounts, and each may be issued by a different credit instrument issuing facility 306a-306n (collectively “credit instrument issuing facilities 306”). For example, cardholder 304 has credit card account 308a issued by credit instrument issuing facility 306a, credit card account 308b issued by credit instrument issuing facility 306b, and credit card account 308n issued by credit instrument issuing facility 306n. Collectively, credit card accounts 308a-308n are “credit card accounts 308.”

Credit card balance transfer system 300 may include a credit instrument issuing facility 310 that is in communication with refinance entity 302 for transferring or facilitating transfer of the balances of 308 from credit instrument issuing facilities 306 to credit instrument issuing facility 310. Refinance entity 302 may further transfer or facilitate the transfer of a refinanced debt credit card account 312 from credit instrument issuing facility 310 to cardholder 304.

In one embodiment, refinance entity 302 communicates with one or more credit reporting agency 316 to transmit credit report requests and receive credit reports for cardholders 304.

In one embodiment, credit instrument issuing facilities 102, 212, 310 subscribe and/or are members of credit card balance transfer systems 100, 200, 300 to enable them to receive one or more summary report 900 (FIG. 9) for a particular cardholders 104, 204, 304 applying to transfer one or more of their credit card accounts 106, 206, 308 to credit instrument issuing facilities 102, 212, 310 in exchange for issuance of refinanced debt credit card accounts 108, 208, 312.

Credit card balance transfer systems 100, 200, 300 may include any number of credit instrument issuing facilities 102, 212, 310. Refinanced debt credit card accounts 108, 208, 312 means an entity that is generally considered a financial institution that issues credit and credit cards to consumers. Some non-limiting examples of refinanced debt credit card accounts 108, 208, 312 include banks, financial institutions, lenders, creditors, etc. cardholders 104 means an entity, individual, and/or company that uses credit cards for purchasing goods and services. Some non-limiting examples of cardholders 104 include, credit card holders, borrowers, debtors, etc.

Credit card accounts 106 may be any type of credit cards commonly known to those skilled in the art. Credit reporting agencies 112, 214, 316 may be any of the commonly known credit reporting agencies.

Referring now to FIG. 4, several embodiments of communication links 110, 210, 314 are shown. For example, communication link 402 may be an Internet based link including networking and computing devices enabling cardholders 104, 204, 304 to communicate with credit instrument issuing facility 102, credit reporting agency 112, refinance entity 202, credit instrument issuing facilities 212, credit reporting agency 214, refinance entity 302, and credit instrument issuing facility 310. Additionally, communication link 404 may be telephone links enabling cardholders 104, 204, 304 to communicate with credit instrument issuing facility 102, credit reporting agency 112, refinance entity 202, credit instrument issuing facilities 212, credit reporting agency 214, refinance entity 302, and credit instrument issuing facility 310.

Further, communication link 406 may be a fax based system using telephone links enabling cardholders 104, 204, 304 to communicate with credit instrument issuing facility 102, credit reporting agency 112, refinance entity 202, credit instrument issuing facilities 212, credit reporting agency 214, refinance entity 302, and credit instrument issuing facility 310. Communication link 408 may be a paper based system enabling cardholders 104, 204, 304 to communicate with credit instrument issuing facility 102, credit reporting agency 112, refinance entity 202, credit instrument issuing facilities 212, credit reporting agency 214, refinance entity 302, and credit instrument issuing facility 310. Any one or more of the above and other known communication links may be used to facilitate communication between cardholders 104, 204, 304 and credit instrument issuing facility 102, credit reporting agency 112, refinance entity 202, credit instrument issuing facilities 212, credit reporting agency 214, refinance entity 302, and credit instrument issuing facility 310.

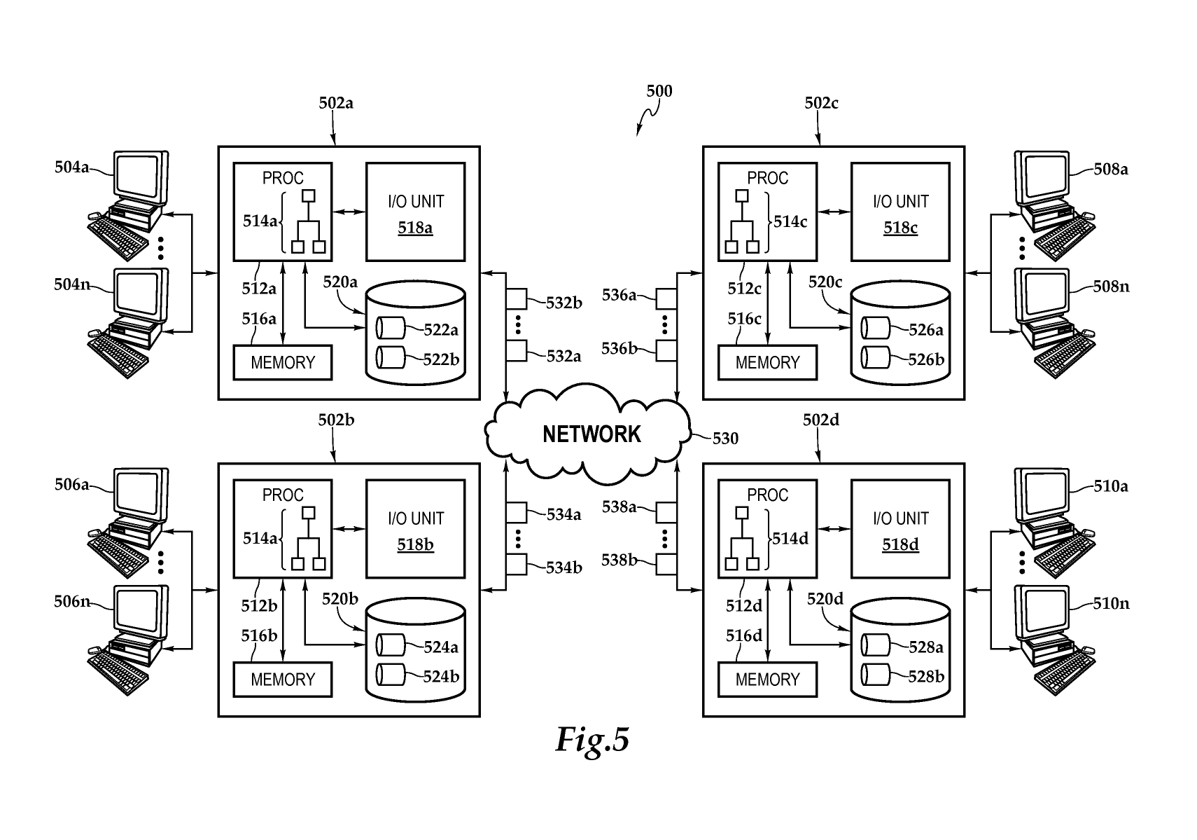

Turning now to FIG. 5, an embodiment of an exemplary network of computers utilized by credit card balance transfer systems 100, 200, 300 are shown. Cardholders 104, 204, 304 may utilize one or more servers 502a. Server(s) 502a may host personal computers 504a-504n (collectively “personal computers 504”) utilized by cardholders 104, 204, 304. Additionally, refinance entities 202, 302 may utilize one or more servers 502b. Server(s) 502b may host personal computers 506a-506n (collectively “personal computers 506”) utilized by refinance entities 202, 302.

Credit instrument issuing facilities 102, 212, 310 may utilize one or more servers 502c. Server(s) 502c may host personal computers 508a-508n (collectively “personal computers 508”) utilized by credit instrument issuing facilities 102, 212, 310. Credit reporting agencies 112, 214, 316 may utilize one or more servers 502d. Server(s) 502d may host personal computers 510a-510n (collectively “personal computers 510”) utilized by credit reporting agencies 112, 214, 316. Collectively, servers 502a-502d are “servers 502.”

In one embodiment, personal computers 504, 506, 508, 510 may be one or more wireless communication devices, such as cell phones, mobile phones, smart phones, and the like (not shown). In this embodiment, wireless networks (not shown) commonly know to those skilled in the art may facilitate transmission of data and information described herein to these type devices for facilitating the systems and methods described herein to a user of the devices. Software applications located on these devices may provide instructions for displaying to users GUIs on the device for entering data and information and displaying information to the users as described herein.

Server 502a may include a processor 512a that executes software 514a. Processor 512a may be in communication with memory 516a, an input/output (“I/O”) unit 518a, and a storage unit 520a. Storage unit 520a may store databases or data repositories 522a-522b thereon. Software 514a may include instructions for execution by processor 512a for providing and/or receiving network connectivity and computer status information in accordance with credit card balance transfer systems. In one embodiment, software 514a may be composed of input forms or GUIs for providing general information, financial information, accepting offers from credit instrument issuing facilities and refinance entities, and the like relating to cardholders 104, 204, 304 and credit card accounts 106, 206, 308 of cardholders 104, 204, 304 and software program further described herein. Server 502a may be physically located or utilized by cardholders 104, 204, 304.

As discussed above, refinance entities 202, 302 may utilize server 502b, which may include a processor 512b that executes software 514b. Processor 512b may be in communication with memory 516b, I/O unit 518b, and storage unit 520b. Storage unit 520b may store databases or data repositories 524a-524b thereon. Software 514b may include instructions for execution by processor 512b for providing network connectivity and computer status information in accordance with credit card balance transfer systems. In one embodiment, software 514b may be composed of input forms or GUIs for providing and/or receiving general information, financial information, accepting offers from credit instrument issuing facilities and refinance entities, and the like relating to cardholders 104, 204, 304 and credit card accounts 106, 206, 308 of cardholders 104, 204, 304 and software program further described herein. Server 502b may be physically located or utilized by refinance entities 202, 302.

Also as discussed above, credit instrument issuing facilities 102, 212, 310 may utilize server 502c, which may include a processor 512c that executes software 514c. Processor 512c may be in communication with memory 516c, I/O unit 518c, and storage unit 520c. Storage unit 520c may store databases or data repositories 526a-526b thereon. Software 514c may include instructions for execution by processor 512c for providing network connectivity and computer status information in accordance with credit card balance transfer systems. In one embodiment, software 514c may be composed of input forms or GUIs for providing and/or receiving general information, financial information, accepting offers from credit instrument issuing facilities and refinance entities, and the like relating to cardholders 104, 204, 304 and credit card accounts 106, 206, 308 of cardholders 104, 204, 304 and software program further described herein. Server 502c may be physically located or utilized by credit instrument issuing facilities 102, 212, 310.

Additionally, credit reporting agencies 112, 214, 316 may utilize server 502d, which may include a processor 512d that executes software 514d. Processor 512d may be in communication with memory 516d, I/O unit 518d, and storage unit 520d. Storage unit 520d may store databases or data repositories 528a-528b thereon. Software 514d may include instructions for execution by processor 512d for providing network connectivity and computer status information in accordance with credit card balance transfer systems. In one embodiment, software 514d may be composed of input forms or GUIs for providing and/or receiving general information, financial information, and the like relating to cardholders 104, 204, 304 and credit card accounts 106, 206, 308 of cardholders 104, 204, 304 and software program further described herein. Server 502d may be physically located or utilized by credit reporting agencies 112, 214, 316. Collectively, software 514a, 514b, 514c, 514d is “software 514.”

Although, one server is shown relative to each of cardholders 104, 204, 304, refinance entities 202, 302, credit instrument issuing facilities 102, 212, 310, and credit reporting agencies 112, 214, 316, any number of servers and personal computers may be employed by any of the entities described herein. Additionally, any of the entities described herein may utilize different servers and personal computers than those described herein as would be understood by one skilled in the arts.

Each of servers 502 may communicate via a network 530. Network 530 may be the Internet, intranet, WANs, LANs, or other communication systems capable of communicating information between computing devices, such as personal computers and the like. Servers 502 may communicate data packets 532a-532b, 534a-534b, 536a-536b, 538a-538 via network 530 containing information related to any of input forms or GUIs for providing and/or receiving general information, financial information, accepting offers from credit instrument issuing facilities and refinance entities, and the like relating to cardholders 104, 204, 304 and credit card accounts 106, 206, 308 of cardholders 104, 204, 304, credit reports, offers, and the like and software program further described herein to any other servers 502, as understood in the art. In addition, network 530 may be a communications network, a computer network, an Internet network, or a combination of them, and the like.

In operation, personal computers 504, 506, 580, 510 and servers 502 may execute software 514 to enable users or cardholders 104, 204, 304 of credit card balance transfer systems 100, 200, 300 to communicate and provide information to each other, for example, either directly or indirectly via network 530. Personal computers 504 may also include other peripherals, such as keyboards, displays, microphones, and the like.

One feature of software 514 is that it enables users or cardholders 104, 204, 304 to provide and receive data and information to and from each other for transferring and refinancing credit card accounts 106, 206, 308 of cardholders 104, 204, 304, for example. The data required to implement this process may include name of cardholder, address of cardholder, home telephone number, work telephone number, cell number, social security number, annual household income, credit card information, such as credit card number, issuer, current existing balance, current APR on balance, current minimum monthly payment, credit limit, annual fee, consolidated debt/balance transfer amount, blended APR on the debt, consolidated credit limit, requests for “soft pull” with credit bureaus, terms and conditions to transfer all balances, credit limit to single credit card, consent to close existing credit card accounts, pre-approval information, approval information, consent of refinance entity to act as proxy on behalf of cardholder, introductory APR on balance transfer, fixed APR on balance transfer, balance transfer fee, purchase APR, introductory purchase APR, rewards terms, “hard hit” with credit bureaus, employer's name, job description, length of employment, mortgage/rent payment, open-to-buys (“OTB”), guaranteed pre-approved offers from credit instrument issuing facilities 102, 212, 310.

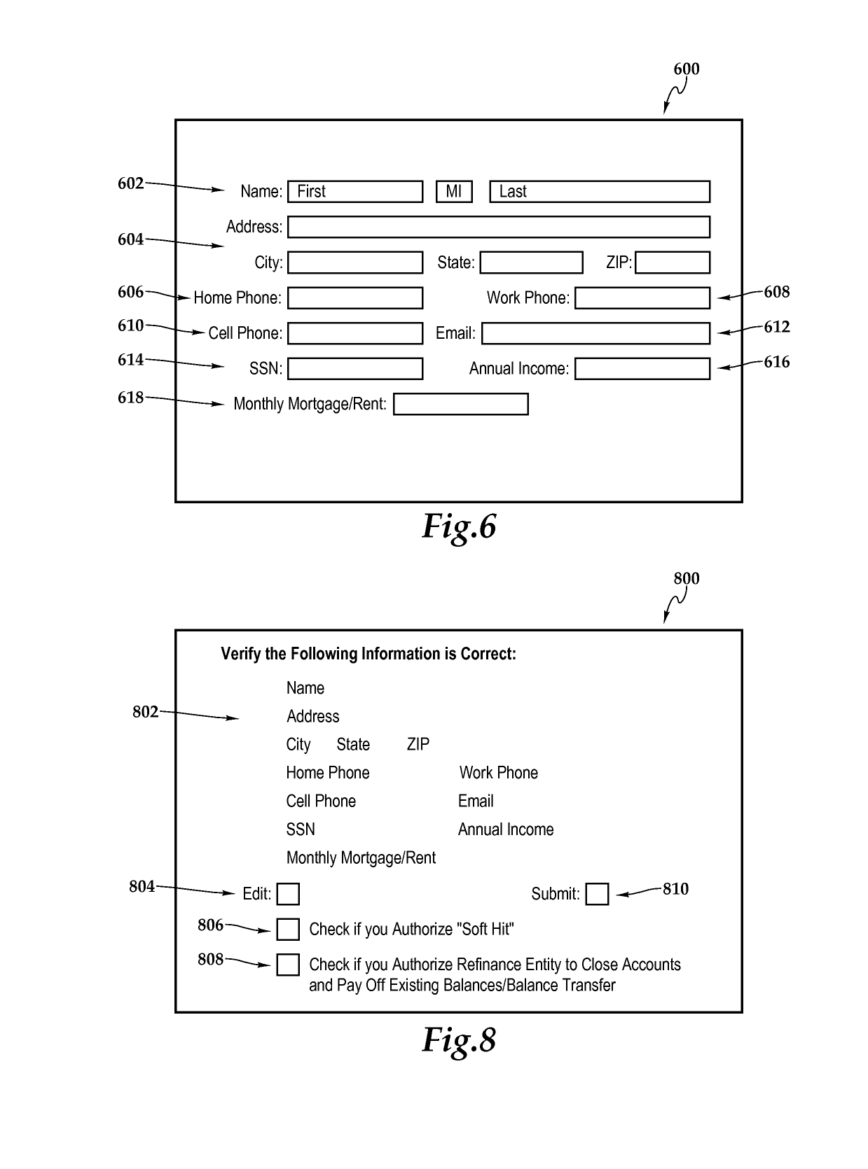

Referring now to FIG. 6, an embodiment of an exemplary display/screen shot from a GUI of an application form 600 from a GUI showing several data fields relating to requested information from cardholders 104, 204, 304 submitting a request for refinance and transfer of existing credit card accounts 106, 206, 308 is shown.

Application form 600 may include a name field 602 for inputting the name of cardholders 104, 204, 304. Name field 602 may include fields for the first, middle, and last name of cardholders 104, 204, 304. Application form 600 further may include an address field 604 for inputting the address of cardholders 104, 204, 304. Address field 604 may include fields for street address, city, state, and zip code of cardholders 104, 204, 304. Additionally, application form 600 may include a home telephone field 606 for inputting the home telephone number of cardholders 104, 204, 304. Application form 600 may further include a work telephone field 608 for inputting the work telephone number of cardholders 104, 204, 304. A cell telephone number field 610 may also be included on application form 600 for inputting the mobile or cellular telephone number of cardholders 104, 204, 304. Also, application form 600 may include an email address field 612 for inputting the email address of cardholders 104, 204, 304. It may also include an social security number field 614 for inputting the social security number of cardholders 104, 204, 304.

Additionally, application form 600 may include an annual income field 616 for inputting the annual income of cardholders 104, 204, 304. Further, application form 600 may include a monthly mortgage/rent field 618 for inputting the monthly mortgage/rent of cardholders 104, 204, 304.

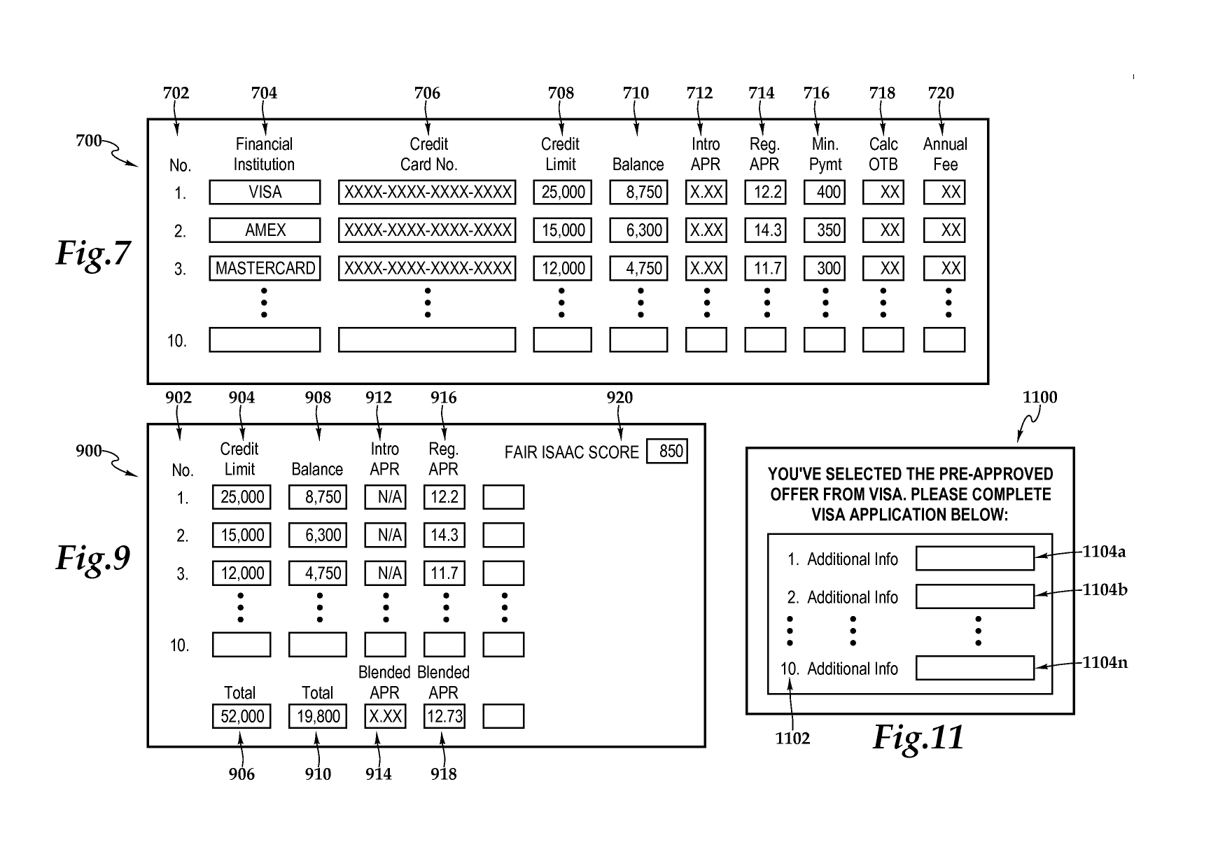

Referring now to FIG. 7, an embodiment of an exemplary display/screen shot from a GUI of an application form 700 for inputting additional information regarding all credit card accounts 106, 206, 308 of cardholders 104, 204, 304. For example, application form 700 may include a number field 702 listing the number of credit card accounts 106, 206, 308 that may be entered by cardholders 104, 204, 304. For example, application form 700 may display one or more numbers listing the credit card accounts 106, 206, 308. Additionally, application form 700 may include a financial institution field 704 for inputting the financial institutions of the credit card accounts 106, 206, 308 of users or cardholders 104, 204, 304. Any number of number field 702 may be included on application form 700. Some exemplary financial institutions shown may be VISA®, AMERICAN EXPRESS®, DISCOVER CARD®, and MASTERCARD®. Further, application form 700 may include a credit card number field 706 for inputting the credit card numbers associated with each of the financial institutions of credit card accounts 106, 206, 308 by a user or cardholders 104, 204, 304.

Also, application form 700 may include a credit limit field 708 for inputting the credit limit associated with each of credit card accounts 106, 206, 308 of cardholders 104, 204, 304 listed in financial institution field 704 and credit card number field 706. The number and/or amount entered in credit limit field 708 may be the entire credit limit offered or provided by each of credit card accounts 106, 206, 308 of cardholders 104, 204, 304. For example, in “1” of number field number field 702, a credit limit of $25,000 is entered into credit limit field 708 for this particular credit card accounts 106, 206, 308 of cardholders 104, 204, 304. Application form 700 may also include a balance field 710 for inputting the balance associated with each of credit card accounts 106, 206, 308 of cardholders 104, 204, 304. The number and/or amount entered in balance field 710 may be the balance of charges, purchases, and/or cash advances on a particular credit card accounts 106, 206, 308 by cardholders 104, 204, 304. For example, in “1” of balance field 710, a balance of $8,750 is entered reflecting the amount of charges, purchases, and/or cash advances particular cardholders 104, 204, 304 have on their particular credit card accounts 106, 206, 308.

Application form 700 may also include an introductory APR field 712 for inputting the introductory APR associated with a particular credit card accounts 106, 206, 308 of cardholders 104, 204, 304. This introductory APR may be an APR offered by a particular credit card accounts 106, 206, 308 that may still be in effect for particular credit card accounts 106, 206, 308 of cardholders 104, 204, 304. It may also include a regular or fixed APR field 714 for inputting a regular or fixed APR associated with a particular credit card accounts 106, 206, 308 of cardholders 104, 204, 304. For example, in “1” of fixed APR field 714, a fixed APR of 12.2% is entered reflecting the amount of APR credit card accounts 106, 206, 308 may charge cardholders 104, 204, 304. Application form 700 may also include a minimum payment field 716 for inputting a minimum payment required of a cardholders 104, 204, 304 to pay credit card accounts 106, 206, 308. For example, in “1” of minimum payment field 716, a minimum payment of $400 entered reflecting the minimum amount of a payment required of cardholders 104, 204, 304 to pay monthly to credit card accounts 106, 206, 308.

Application form 700 may further include a calculated OTB field 718 for inputting a calculated open-to-buys of credit card accounts 106, 206, 308 of cardholders 104, 204, 304. Additionally, application form 700 may include an annual fee field 720 for inputting the annual fee of credit card accounts 106, 206, 308 of cardholders 104, 204, 304.

Turning now to FIG. 8, an embodiment of an exemplary display/screen shot from a GUI of an application form 800 showing the inputted data entered in application form 600 and application form 700 is shown. Some or all of the previously entered and inputted information from application form 600 is displayed in field 802 to users or cardholders 104, 204, 304 for confirmation purposes. A user or cardholders 104, 204, 304 entering some or all of the previous data from application form 600 and application form 700 may view the information or data to confirm that it is accurate. In the event that the information or data needs to be revised, application form 800 may include an edit selection field or button 804 for selecting by a user or cardholders 104, 204, 304 which when selected may present application form 600 and/or application form 700 to user or cardholders 104, 204, 304 for revising any of the information or data contained therein.

Application form 800 may further include an authorization field 806 to enable users or cardholders 104, 204, 304 to select if he/she authorizes credit card balance transfer systems 100, 200, 300 to perform a “soft hit” on one or more credit reporting agencies 112, 214, 316 regarding cardholders 104, 204, 304. Additionally, application form 800 may include an authorization field 808 to enable users or cardholders 104, 204, 304 to select if he/she authorizes credit card balance transfer systems 100, 200, 300 act as a proxy for facilitating the closing of existing credit card accounts 106, 206, 308 and transferring all entered credit card accounts 106, 206, 308 to credit instrument issuing facilities 102, 212, 310 and to facilitate the issuance of refinanced debt credit card accounts 108, 208, 312 from credit instrument issuing facilities 102, 212, 310 to users or cardholders 104, 204, 304. Application form 800 may also include a submit field or button 810 for selecting by a user or cardholders 104, 204, 304 to accept and transfer all of the information or data to credit instrument issuing facilities 102, 212, 310 or refinance entities 202, 302 as the case may be.

Referring now to FIG. 9, an embodiment of an exemplary display/screen shot from a GUI of a summary report 900 showing an exemplary summary of one or more of the inputted information and/or data entered in application forms 600, 700, 800 is shown. Summary report 900 may include a number field 902 listing the number of credit card accounts 106, 206, 308 that may have been entered by cardholders 104, 204, 304. For example, summary report 900 may display one or more numbers listing the credit card accounts 106, 206, 308. Also, summary report 900 may include a credit limit field 904 for displaying the credit limit associated with each of credit card accounts 106, 206, 308 of cardholders 104, 204, 304 listed in number field 902. The number and/or amount entered in credit limit field 708 may be the entire credit limit provided by each of credit card accounts 106, 206, 308 of cardholders 104, 204, 304. For example, in “1” of number field number field 902, a credit limit of $25,000 is entered into credit limit field 904 for this particular credit card account 106, 206, 308 of cardholders 104, 204, 304. Further, credit card balance transfer systems 100, 200, 300 may sum and/or add all of the credit limits entered in credit limit field 904 and present them in a total credit limit field 906 for displaying the total balance information relative to one or more of credit card accounts 106, 206, 308 of cardholders 104, 204, 304. The amount and/or number displayed in total credit limit field 906 may include the sum or addition of all credit limits entered in credit limit field 904. For example, total credit limit field 906 is shown displaying a total credit limit of “$52,000,” which is the sum total of all credit limits entered by cardholders 104, 204, 304 and displayed in credit limit field 904.

Application form 900 may also include a balance field 908 for displaying the balance associated with each of credit card accounts 106, 206, 308 of cardholders 104, 204, 304. The number and/or amount entered in balance field 908 may be the balance of charges, purchases, and/or cash advances on a particular credit card accounts 106, 206, 308 by cardholders 104, 204, 304. For example, in “1” of balance field 908, a balance of $8,750 is entered reflecting the amount of charges, purchases, and/or cash advances particular cardholders 104, 204, 304 has on their particular credit card accounts 106, 206, 308.

Further, credit card balance transfer systems 100, 200, 300 may sum and/or add all of the balances entered in balance field 710 and displayed in balance field 908 and present them in a total balance field 910 for displaying the total balance information relative to one or more of credit card accounts 106, 206, 308 of cardholders 104, 204, 304. The amount and/or number displayed in total balance field 910 may include the sum or addition of all balances entered in balance field 908. For example, total balance field 910 is shown displaying a total balance of “$19,800,” which is the sum total of all balances entered by cardholders 104, 204, 304 and displayed in balance field balance field 908.

Summary report 900 may also include an introductory APR field 912 for displaying the introductory APR associated with a particular credit card accounts 106, 206, 308 of cardholders 104, 204, 304. This introductory APR may be an APR provided by a particular credit card accounts 106, 206, 308 that may still be in effect for particular credit card accounts 106, 206, 308 of cardholders 104, 204, 304.

Further, credit card balance transfer systems 100, 200, 300 may calculate a blended introductory APR of all of the introductory APRs entered in introductory APR field 912 and display a blended introductory APR in a blended introductory APR field 914 for displaying relative to one or more of credit card accounts 106, 206, 308 of cardholders 104, 204, 304. In one embodiment, a blended introductory APR may be calculated by averaging the sums or amounts of introductory APRs entered in introductory APR field 912.

Additionally, summary report 900 may also include a regular or fixed APR field 916 for displaying the regular or fixed APR associated with a particular credit card accounts 106, 206, 308 of cardholders 104, 204, 304. This fixed APR may be an APR provided by a particular credit card accounts 106, 206, 308 that may still be in effect for particular credit card accounts 106, 206, 308 of cardholders 104, 204, 304.

Further, credit card balance transfer systems 100, 200, 300 may calculate a blended fixed APR of all of the fixed APRs entered in fixed APR field 916 and display a blended fixed APR in a fixed APR field 916 for displaying relative to one or more of credit card accounts 106, 206, 308 of cardholders 104, 204, 304. In one embodiment, a blended fixed APR may be calculated by averaging the sums or amounts of fixed APRs entered in fixed APR field 916.

Further, summary report 900 may display a FAIR ISAAC credit score in a credit score field 920 for a particular cardholders 104, 204, 304 that was received based on the “soft hit” credit score inquiry discussed above and herein. For example, a credit score of “850” is shown displayed in credit score field 920 of summary report 900.

As discussed further below, credit instrument issuing facilities 102, 212, 310 may subscribe and/or be members of credit card balance transfer systems 100, 200, 300 to enable them to be sent summary report 900 for their review to determine whether they desire to extend an pre-approved offer for credit based on the information provided in summary report 900.

In one embodiment, the data and/or information provided in summary report 900 may be gleaned from some or all of the data or information provided by cardholders 104, 204, 304 in application forms 600, 700, 800. Credit card balance transfer systems 100, 200, 300 may delete some information provided to it before preparing application forms 600, 700, 800.

In one embodiment, summary report 900 is displayed to one or more of credit instrument issuing facilities 102, 212, 310 for determining whether one or more of credit instrument issuing facilities 102, 212, 310 desires to provide an offer to refinance entities 202, 302 and/or credit card accounts 106, 206, 308 as discussed further below.

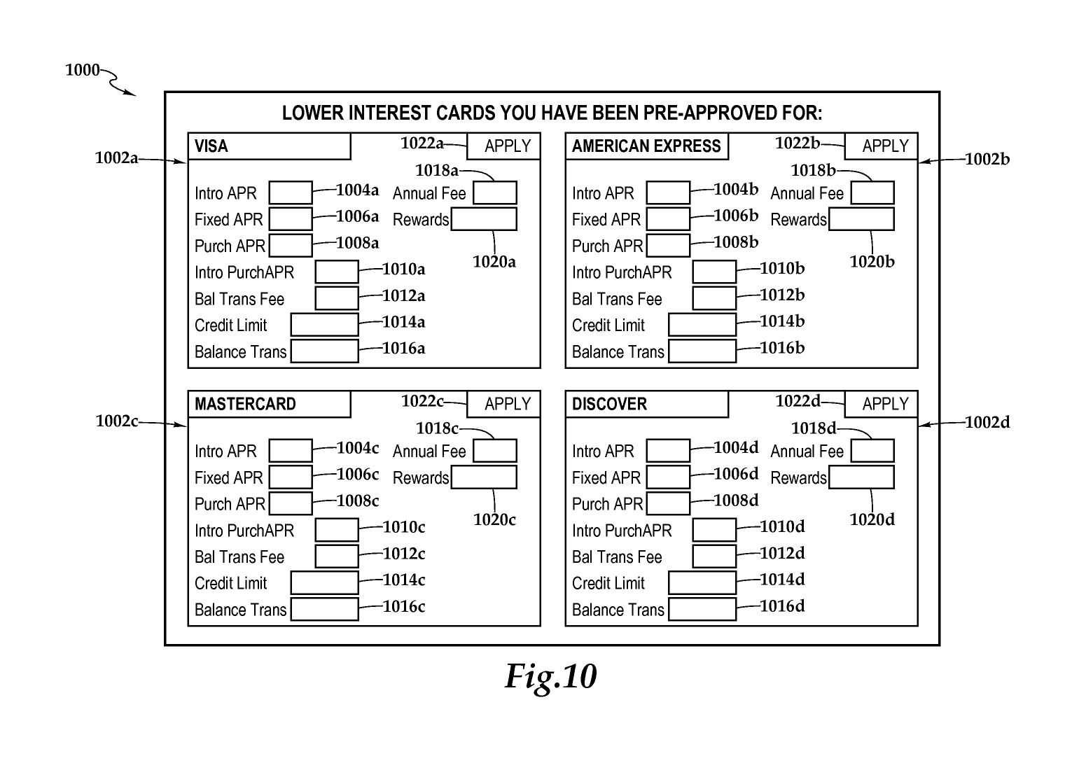

Now referring to FIG. 10, an embodiment of an exemplary display/screen shot from a GUI of several preapproved balance transfer offers 1000 from credit instrument issuing facilities 102, 212, 310 are shown. In one embodiment, credit card balance transfer system 100 may include one or more preapproved balance transfer offers from one or more credit instrument issuing facilities 102, 212, 310. For example, credit card balance transfer system 100 includes a preapproved balance transfer offer from VISA® 1002a; a preapproved balance transfer offer from AMEX® 1002b; a preapproved balance transfer offer from MASTERCARD® 1002c; and a preapproved balance transfer offer from DISCOVER® 1002d. Collectively preapproved balance transfer offers 1002a-1002d are “preapproved balance transfer offers preapproved balance transfer offers 1002.”

As discussed herein, after reviewing summary report 900 provided by credit card balance transfer systems 100, 200, 300, credit instrument issuing facilities 102, 212, 310 may desired to extend one or more preapproved balance transfer offers 1002 to refinance entities 202, 302 and/or cardholders 104, 204, 304. Preapproved balance transfer offers 1002 may include an introductory APR 1004a-1004d (collectively “introductory APR 1004”) offered to cardholders 104, 204, 304 by credit instrument issuing facilities 102, 212, 310. Additionally, preapproved balance transfer offers 1002 may include a regular or fixed APR 1006a-1006d (collectively “fixed APR 1006”) offered to cardholders 104, 204, 304 by credit instrument issuing facilities 102, 212, 310. Further, preapproved balance transfer offers 1002 may include one or more purchase APR 1008a-1008d (collectively “purchase APR 1008”) offered to cardholders 104, 204, 304 by credit instrument issuing facilities 102, 212, 310.

Also, preapproved balance transfer offers 1002 may include one or more introductory purchase APR 1010a-1010d (collectively “introductory purchase APR 1010”) offered to cardholders 104, 204, 304 by credit instrument issuing facilities 102, 212, 310. Preapproved balance transfer offers 1002 may further include one or more balance transfer fees 1012a-1012d (collectively “balance transfer fees 1012”) that may be charged to cardholders 104, 204, 304 by credit instrument issuing facilities 102, 212, 310. In addition, preapproved balance transfer offers 1002 may further include one or more credit limits 1014a-1014d (collectively “credit limits 1014”) offered to cardholders 104, 204, 304 by credit instrument issuing facilities 102, 212, 310.

In one embodiment, credit limits 1014 may be a credit limit that includes all of the credit limits cumulatively provided by cardholders 104, 204, 304.

Preapproved balance transfer offers 1002 may further include one or more balance transfer amounts 1016a-1016d (collectively “balance transfer amounts 1016”) that are being transferred from credit card accounts 106, 206, 308 of cardholders 104, 204, 304 to credit instrument issuing facilities 102, 212, 310.

In one embodiment, balance transfer amounts 1016 may include all of the balances cumulatively provided by cardholders 104, 204, 304.

Additionally, preapproved balance transfer offers 1002 may further include one or more annual fees 1018a-1018d (collectively “annual fees 1018”) the may be charged by credit instrument issuing facilities 102, 212, 310 to cardholders 104, 204, 304. Also, preapproved balance transfer offers 1002 may include one or more rewards 1020a-1020d (collectively “rewards 1020”) that may be offered by credit instrument issuing facilities 102, 212, 310 to cardholders 104, 204, 304.

In one embodiment, preapproved balance transfer offers 1002 may include an “apply” button or selection 1022a-1022d (collectively “apply button 1022”) for selecting by a user or cardholders 104, 204, 304 once they've made a decision regarding which one of preapproved balance transfer offers 1002 they desire to accept. In this embodiment, users or cardholders 104, 204, 304 review all of the data and/or information provided in preapproved balance transfer offers 1002 to make a decision regarding which offer they desire, and then by clicking or selecting apply button 1022 to forward the selected offer and information to refinance entities 202, 302 and/or credit instrument issuing facilities 102, 212, 310 of credit card balance transfer systems 100, 200, 300.

Now referring to FIG. 11, an embodiment of an exemplary display/screen shot from a GUI of a confirmation data field 1100 from the selected credit instrument issuing facilities 102, 212, 310 that may notify a user and/or cardholders 104, 204, 304 that may confirm their acceptance of a particular preapproved offer and may request additional information by the selected one of credit instrument issuing facilities 102, 212, 310 from cardholders 104, 204, 304. Credit card balance transfer system 100 may include a number field 1102 listing the number of additional requests for information 1104a-1104d (collectively “additional requests for information 1104”) from cardholders 104, 204, 304.

The above mentioned forms, are exemplary, and the data contained or inputted into them may be inputted by other individuals from paper forms provided by cardholders 104, 204, 304. Any other known means for inputting this information may also be used as known to those skilled in the art.

The following discussion is provided with respect to one embodiment of credit card balance transfer systems 100, 200, 300; however, it also applies to any of the other embodiments of credit card balance transfer systems 100, 200, 300 as described herein.

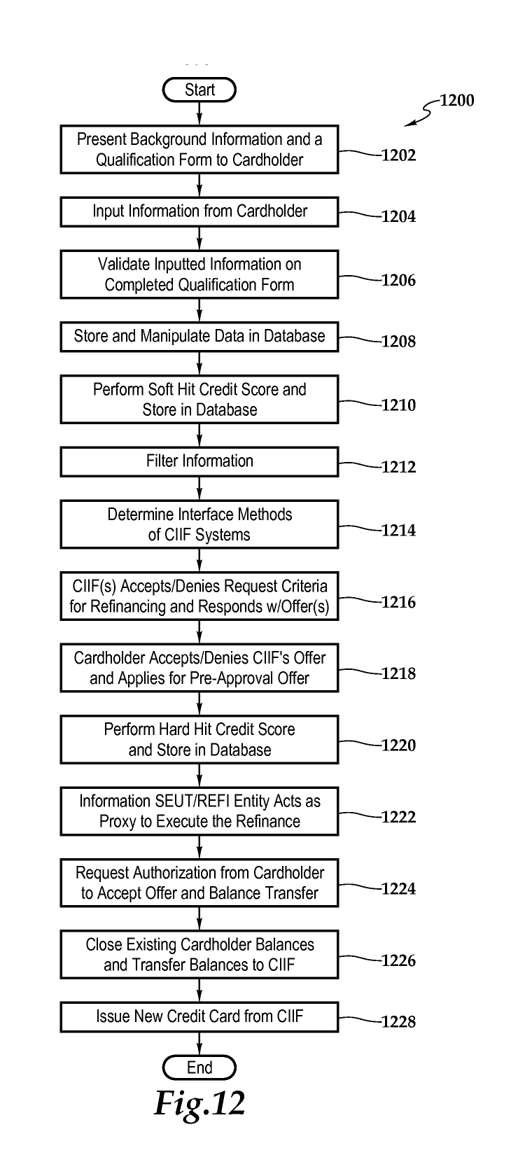

The credit card balance transfer systems 100, 200, 300 further includes methods of transferring existing credit card balances to a credit instrument issuing facility. Referring now to FIGS. 12A-12B, a method of transferring existing credit card balances to a credit instrument issuing facility 1200 is now shown.

In step 1202, credit card balance transfer systems 100, 200, 300 presents one or more application forms 600, 700, 800 to a user or cardholders 104, 204, 304. This step may be performed by any means commonly known to those skilled in the art, including any of communication links 402, 404, 406, 408. The presentation of application forms 600, 700, 800 may be via a paper-based system where forms are mailed out to a user or cardholders 104, 204, 304. The presentation of the forms also may be via a paper-based system where forms are faxed via a typical telecommunications system. Further, as discussed herein, application forms 600, 700, 800 may be transmitted between a user and/or cardholders 104, 204, 304 and credit card balance transfer systems 100, 200, 300 via an electronic based system, such as over the Internet. In another embodiment, this step may be performed in a telephone call between a user and/or cardholders 104, 204, 304 and a representative of credit card balance transfer systems 100, 200, 300.

Next, in step 1204, a user and/or cardholders 104, 204, 304 receives application forms 600, 700, 800 and completes and/or inputs the information requested on application forms 600, 700, 800. In one embodiment, this process is done directly on paper forms, and in another embodiment, this process may be done directly into a computer based system using GUIs, electronic forms, and the like as discussed herein. This step may further include inputting requested information and/or data relating to one or more credit card accounts 106, 206, 308 that a particular user and/or cardholders 104, 204, 304 may possess. Additionally, this step may include transmitting the completed application forms 600, 700, 800 to refinance entities 202, 302 and/or credit instrument issuing facilities 102, 212, 310 of credit card balance transfer systems 100, 200, 300.

In step 1206, refinance entities 202, 302 and/or credit instrument issuing facilities 102, 212, 310 of credit card balance transfer systems 100, 200, 300 may validate the inputted data and/or information provided by a user and/or cardholders 104, 204, 304. This may include checking to make sure all data and/or information is correct and complete. In step 1208, credit card balance transfer systems 100, 200, 300 may store the data and/or information provided on application forms 600, 700, 800 by a user and/or cardholders 104, 204, 304 onto one or more computer systems as described herein.

In step 1210, refinance entities 202, 302 and/or credit instrument issuing facilities 102, 212, 310 of credit card balance transfer systems 100, 200, 300 may then request a “soft pull” credit check from the credit reporting agencies 112, 214, 316 based on the data and/or information provided by the cardholders 104, 204, 304.

In step 1212, credit card balance transfer systems 100, 200, 300 may filter the information provided by a user and/or cardholders 104, 204, 304 on application forms 600, 700, 800 so as to remove, filter, and/or conceal certain personal information that may not be required in subsequent steps for providing preliminary information to credit instrument issuing facilities 102, 212, 310 for their consideration to provide preapproved refinance and consolidation credit card offers to cardholders 104, 204, 304.

In step 1214, credit card balance transfer systems 100, 200, 300 may determine the computer, network, paper-based, and/or telephonic based interface protocols of credit instrument issuing facilities 102, 212, 310 for determining how to transmit data and/or information regarding one or more cardholders 104, 204, 304 provided on application forms 600, 700, 800 to refinance entities 202, 302 and/or credit instrument issuing facilities 102, 212, 310. This step may also include transmitting the filtered data and/or information contained or stored on application forms 600, 700, 800 to credit instrument issuing facilities 102, 212, 310 for their consideration to provide such offers to cardholders 104, 204, 304. In general, the credit instrument issuing facilities 102, 212, 310 that may be transmitted this data and/or information are subscribers and/or members of one or more of credit card balance transfer systems 100, 200, 300.

In step 1216, one or more of credit instrument issuing facilities 102, 212, 310 may determine whether to extend an offer to consolidate and refinance all of the credit card accounts 106, 206, 308 of cardholders 104, 204, 304 based upon the provided, stored, and/or filtered information contained on application forms 600, 700, 800 provided by cardholders 104, 204, 304. This step may include credit instrument issuing facilities 102, 212, 310 determining whether they desire to offer such refinancing based upon the information provided in some or all of application forms 600, 700, 800. For example, credit instrument issuing facilities 102, 212, 310 may determine if they can provide a fixed APR that is the same as or less than the blended fixed APR calculated by credit card balance transfer systems 100, 200, 300. If so, then credit instrument issuing facilities 102, 212, 310 may desire to provided one or more preapproved balance transfer offers 1002. As discussed herein, any number of credit instrument issuing facilities 102, 212, 310 may transmit such preapproved balance transfer offers 1002.

In one embodiment, this step may further include credit instrument issuing facilities 102, 212, 310 providing the one or more preapproved balance transfer offers 1002 to refinance entities 202, 302, which may transmit the one or more preapproved balance transfer offers 1002 to cardholders 104, 204, 304. In another embodiment, this step may include credit instrument issuing facilities 102, 212, 310 providing the one or more preapproved balance transfer offers 1002 directly to cardholders 104, 204, 304.

In step 1218, after receiving the one or more preapproved balance transfer offers 1002, a user and/or cardholders 104, 204, 304 may determine if they desire to accept one preapproved balance transfer offers 1002. This step may include the apply button 1022 being activated on preapproved balance transfer offers 1002.

In step 1220, upon activation of apply button 1022, credit card balance transfer systems 100, 200, 300 may then perform a “hard hit” credit check at one or more of credit reporting agencies 112, 214, 316 for the cardholders 104, 204, 304. This hard hit credit check may include more information provided than with the soft hit credit check for acquiring a more detailed or accurate credit score that may be stored in credit card balance transfer systems 100, 200, 300.

In step 1222, credit card balance transfer systems 100, 200, 300 forwarding any additional requests for information 1104 that one or more of credit instrument issuing facilities 102, 212, 310 may request to a user and/or cardholders 104, 204, 304. Additionally, it may include forwarding the responses inputted into additional requests for information 1104 by a user and/or cardholders 104, 204, 304.

In step 1224, upon receiving all additional requests for information 1104, any other information requested by credit instrument issuing facilities 102, 212, 310, and the authorization for refinance entities 202, 302 to act as a proxy on behalf of a user and/or cardholders 104, 204, 304, credit card balance transfer systems 100, 200, 300 may send a final request for authorization to cardholders 104, 204, 304 including final refinanced preapproved balance transfer offers 1002 from credit instrument issuing facilities 102, 212, 310. This step may include summarizing all credit card accounts 106, 206, 308 that are being closed by refinance entities 202, 302 and/or credit instrument issuing facilities 102, 212, 310 and the associated balances, credit limits, and the like that are being refinanced with newly issued refinanced debt credit card accounts 108, 208, 312 by credit instrument issuing facilities 102, 212, 310.

In step 1226, credit card balance transfer systems 100, 200, 300 having received authorization from cardholders 104, 204, 304 to close out existing credit card accounts 106, 206, 308, may pay-off and transfer existing credit card accounts 106, 206, 308 to new credit instrument issuing facilities 102, 212, 310. Credit card balance transfer systems 100, 200, 300 closes the balances of credit card accounts 106, 206, 308 of cardholders 104, 204, 304 and transfers them to the approved or accepted credit instrument issuing facilities 102, 212, 310. Credit card balance transfer systems 100, 200, 300 may use refinance entities 202, 302 to perform this step or it may be performed directly by credit instrument issuing facilities 102, 212, 310.

In step 1228, a new refinanced debt credit card accounts 108, 208, 312 may be issued by credit instrument issuing facilities 102, 212, 310 to cardholders 104, 204, 304.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for transferring existing credit card balances to a credit instrument issuing facility comprising:
a refinance entity in communication with cardholders of one or more credit card accounts, the refinance entity capable of providing application forms to the cardholders for inputting information regarding the one or more credit card accounts for applying to refinance all of the one or more credit card accounts, the application forms including fields for at least one of personal information, existing credit card account number, credit limit, existing balance, and fixed annual percentage rate associated with the each of the one or more credit card accounts;
at least one credit reporting agency in communication with the refinance entity for providing credit reports of the cardholders to the refinance entity; and
at least one credit instrument issuing facility in communication with the refinance entity for accepting a summary report of the inputted application forms including a blended annual percentage rate from the refinance entity, the at least one credit instrument issuing facility capable of issuing a refinanced debt credit card account to the cardholders to replace all of the one or more credit card accounts, wherein the refinance entity controls the closing on behalf of cardholders of all of the one or more credit card accounts, transferring of the balances of the credit card accounts to the at least one credit instrument issuing facility, and issuing of the refinanced debt credit card account.

2. The system as recited in claim 1, wherein the refinance entity provides a proxy selection to be selected by the cardholders authorizing the refinance entity to close all of the one or more credit card accounts and transfer the all of the balances of one or more credit card accounts to the at least one credit instrument issuing facility's refinanced debt credit card account.

3. The system as recited in claim 1, wherein the at least one credit instrument issuing facility provides a preapproved balance transfer offer to the refinance entity based on the summary report.

4. The system as recited in claim 3, wherein the refinance entity provides the preapproved balance transfer offer to the cardholders for viewing the preapproved balance transfer offers associated with the refinanced debt credit card account to make a selection of one of the preapproved balance transfer offers.

5. The system as recited in claim 1, wherein the blended annual percentage rate is an average of all of the annual percentage rates of all of the one or more credit card accounts provided by cardholders.

6. The system as recited in claim 1, wherein the summary report provides a total of each of the fields for the at least one of credit limit and existing balance associated with the each of the one or more credit card accounts.

7. The system as recited in claim 1, wherein issuing of the refinanced debt credit card account includes:
a credit limit at least equal to the combined credit limit of all transferred credit limits and a fixed annual percentage rate that is less than, more than, or is the same as the verified blended annual percentage rate of the existing credit cards.

8. An electronic computer based system for transferring existing credit card balances to a credit instrument issuing facility comprising:
an electronic input device for producing input signals;
a display;
an electronic memory storing application forms for one or more credit card accounts of a cardholder, the application forms including at least one of cardholder's personal information, credit card account numbers, credit limits, existing balances, and fixed annual percentage rates associated with the each of the one or more credit card accounts;
an electronic processor communicating with the memory and the display and responsive to input signals to:
direct the display to display the application forms to the cardholder for receiving input of the at least one of cardholder's personal information, credit card account numbers, credit limits, existing balances, and fixed annual percentage rates associated with the each of the one or more credit card accounts;
receive input into the data fields relating to the at least one of cardholder's personal information, credit card numbers, credit limits, existing balances, and fixed annual percentage rates associated with the each of the one or more credit card accounts;
receive a credit score report for the cardholder;
transmit to one or more credit instrument issuing facilities a summary report containing the at least one of the credit limits, existing balances, and fixed annual percentage rates associated with the each of the one or more credit card accounts and the credit score report;
receive one or more preapproved balance transfer offers from one or more credit instrument issuing facilities based on the summary report;
transmit to the cardholder the one or more preapproved refinanced debt credit card account and balance transfer offers including an apply selection and proxy selection for each refinanced debt credit card account and preapproved balance transfer offers;
responsive to selecting one of the apply selections and proxy selections associated with one of the one or more credit instrument issuing facilities by the cardholder, transmit the accepted preapproved refinanced debt credit card account and balance transfer offer to the credit instrument issuing facility;
receive acceptance from the accepted credit instrument issuing facilities for transferring the one or more credit card accounts; and
responsive to receiving the acceptance from the accepted credit instrument issuing facility,
transfer all balances and credit limits of the one or more credit card accounts to the accepted credit instrument issuing facility, and issue a refinanced debt credit card account from accepted credit instrument issuing facility to the cardholder.

9. The electronic computer based system as recited in claim 8, wherein the summary report further includes an average of the annual percentage rates for all of the one or more credit card accounts of the cardholder.

10. The electronic computer based system as recited in claim 8, wherein the summary report provides a total of each of the credit limit and existing balance associated with the each of the one or more credit card accounts.

11. The electronic computer based system as recited in claim 8, wherein the refinanced debt credit card account includes:
a credit limit at least equal to all transferred credit limits and a fixed annual percentage rate that is less than, more than, or is the same as the verified blended annual percentage rate of the existing credit cards.

12. A method for underwriting and transferring existing credit card balances to a credit instrument issuing facility comprising:
displaying to a cardholder one or more application forms including credit limit, existing balance, and fixed annual percentage rate associated with each of the one or more credit card accounts issued to the cardholder;
inputting the credit limit, existing balance, and fixed annual percentage rate associated with each of the one or more credit card accounts issued to the cardholder;
retrieving at least one credit score of the cardholder from one or more credit reporting agencies;
preparing a summary report of the inputted application forms including a blended annual percentage rate of all of the annual percentage rates of the one or more credit card accounts, the retrieved at least one credit score, and a total of each of the fields for the credit limit and existing balance associated with the each of the one or more credit card accounts;
transmitting the summary report to one or more credit instrument issuing facilities;
transmitting to the cardholder one or more preapproved balance transfer offers provided by the one or more credit instrument issuing facilities;
accepting one of the one or more preapproved balance transfer offers offered by the cardholder;
transferring all of the one or more credit card accounts to the accepted credit instrument issuing facilities; and
issuing a refinanced debt credit card account to the cardholder.

13. The method as recited in claim 12, wherein the transferring the one or more credit card accounts is performed by a refinance entity in communication with the cardholder and the one or more credit instrument issuing facilities.

14. The method as recited in claim 12, wherein the transmitting the summary report to one or more credit instrument issuing facilities further comprises:
determining interface methods of the one or more credit instrument issuing facilities.

15. The method as recited in claim 12, wherein transferring the one or more credit card accounts to the accepted credit instrument issuing facilities further comprises:
transferring all of the balances of the one or more credit card accounts to the accepted credit instrument issuing facility.

16. The method as recited in claim 12, wherein transferring the one or more credit card accounts to the accepted credit instrument issuing facilities further comprises:
transferring all of the cumulative credit limits of the one or more credit card accounts to the accepted credit instrument issuing facility.

17. The method as recited in claim 12, wherein the retrieving at least one credit score of the cardholder comprises:
retrieving a soft hit credit score from the one or more credit reporting agencies.

18. The method as recited in claim 12, wherein the one or more credit instrument issuing facilities are subscribers to receiving the summary report.

19. The method as recited in claim 12, further comprising:
displaying on the application forms a proxy selection for authorizing to close all of the one or more credit card accounts, transferring of the balances of the credit card accounts to the credit instrument issuing facility, and issuing of the refinanced debt credit card account.

20. The method as recited in claim 12, further comprising:
filtering the additional inputted information on the summary report.
